(19) United States
(12) Patent Application Publication
(10) Pub. No.: US 2017/0203557 A1
(43) Pub. Date: Jul. 20, 2017

(54) APPARATUS FOR MANUFACTURING FLEXIBLE SUBSTRATE

(71) Applicant: ELECTRONICS AND TELECOMMUNICATIONS RESEARCH INSTITUTE, Daejeon (KR)

(72) Inventors: Doo-Hee CHO, Daejeon (KR); Jonghee LEE, Daejeon (KR); Byoung-Hwa KWON, Daejeon (KR); Jaehyun MOON, Daejeon (KR); Young Sam PARK, Daejeon (KR); Jin Wook SHIN, Daejeon (KR); Byoung Gon YU, Yongsan-myeon (KR); Jeong Ik LEE, Daejeon (KR); Hyunkoo LEE, Daejeon (KR); Jong Tae LIM, Seoul (KR); Nam Sung CHO, Daejeon (KR); Hyunsu CHO, Daejeon (KR); Chul Woong JOO, Seoul (KR); Jun-Han HAN, Daejeon (KR)

(21) Appl. No.: 15/263,255

(22) Filed: Sep. 12, 2016

(30) Foreign Application Priority Data
Jan. 19, 2016 (KR) 10-2016-0006604

(51) Int. Cl. B32B 37/00; B32B 41/00

(52) U.S. Cl. CPC B32B 37/025; B32B 37/0053; B32B 41/00

(57) ABSTRACT

Provided is an apparatus for manufacturing a flexible integrated substrate. The apparatus for manufacturing the flexible integrated substrate includes a substrate transfer unit configured to transfer a substrate which a functional film is disposed on one surface thereof, a unwinding unit configured to unwind a flexible support film wound in a roll shape, a winding unit configured to wind the support film provided from the unwinding unit in the roll shape, and a pressing unit configured to press the support film being transferred from the unwinding unit to the winding unit to the substrate being transferred to attach the functional film to the support film.

### CROSS-REFERENCE TO RELATED APPLICATIONS

This U.S. non-provisional patent application claims priority under 35 U.S.C. §119 of Korean Patent Application No. 10-2016-0006604, filed on Jan. 19, 2016, the entire contents of which are hereby incorporated by reference.

### BACKGROUND

The present disclosure herein relates to an apparatus for manufacturing a flexible integrated substrate.

Technologies for producing various electronic devices such as electronic circuits, sensors, displays, and solar batteries through printing are emerging. Recently, flexible displays that are bendable, foldable, or rollable without the impairment or degradation in image quality has been in the spotlight beyond flat panel displays. To realize flexible displays, there is a rising need for roll-to-roll technologies and development of technologies relating to a paperlike thin and flexible integrated substrate.

### SUMMARY

The present disclosure provides an apparatus for manufacturing a flexible integrated substrate, which is capable of continuously manufacturing a flexible integrated substrate having a planar and smooth surface. The technical objective of the present disclosure is not limited to the aforesaid, but other objects not described herein will be clearly understood by those skilled in the art from descriptions below.

An embodiment of the inventive concept provides an apparatus for manufacturing a flexible integrated substrate including a substrate transfer unit configured to transfer a substrate, which a functional film is disposed on one surface thereof; an unwinding unit configured to unwind a flexible support film wound in a roll shape; a winding unit configured to wind the support film, which is provided from the unwinding unit, in the roll shape; and a pressing unit configured to press the support film being transferred from the unwinding unit to the winding unit to the substrate being transferred for the functional film to adhere to the support film.

In an embodiment, the apparatus may further include a mark recognizing unit configured to recognize at least one first alignment mark provided on the support film being transferred to acquire first alignment mark information and recognize at least one second alignment mark provided on the substrate being transferred to acquire second alignment mark information.

In an embodiment, the apparatus may further include a controller configured to control the substrate transfer unit and the winding unit so that a transfer speed of the substrate and a transfer speed of the support film are synchronized with each other on the basis of the first alignment mark information and the second alignment mark information.

In an embodiment, the first alignment mark information may include information about a moving distance of the first alignment mark during a preset time, and the second alignment mark information may include information about a moving distance of the second alignment mark during a preset time.

In an embodiment, the mark recognizing unit may include a first mark recognizing unit configured to photograph the support film being transferred and a second mark recognizing unit configured to photograph the substrate being transferred.

In an embodiment, the pressing unit may include a pressing roller of which at least a portion of an outer circumferential surface contacts the support film; a roller driving unit configured to rotate the pressing roller about a virtual rotational axis that passes through a center of the pressing roller; and a roller elevating unit configured to elevate the pressing roller.

In an embodiment, the apparatus may further include a mark recognizing unit configured to recognize a first alignment mark provided on the support film being transferred to acquire first alignment mark information; and a controller configured to calculate a transfer speed of the support film on the basis of the first alignment mark information and control the winding unit and the roller driving unit so that the calculated transfer speed of the support film and a rotating speed of the pressing roller are synchronized with each other.

In an embodiment, the pressing unit may further include an elastic member surrounding the outer circumferential surface of the pressing roller.

In an embodiment, the apparatus may further include a cutting unit configured to cut a portion of the functional film provided on the substrate being transferred toward the pressing unit.

In an embodiment, the support film may include an adhesion layer configured to bond the functional film to the support film.

In an embodiment, the support film may further include a protective film disposed on one surface of the adhesion layer.

In an embodiment, the apparatus may further include a delaminating unit configured to separate the protective film r from the support film being transferred from the unwinding unit to the pressing unit.

In an embodiment, the apparatus may further include a protective film winding unit configured to wind the protective film layer, which is separated from the support film by the delaminating unit, in the roll shape.

In an embodiment, the functional film may include a sacrificial layer contacting the substrate, and the apparatus may further include a sacrificial layer removing unit configured to remove the sacrificial layer of the functional film adhering to the support film.

In an embodiment, the substrate may include a ceramic material, and the sacrificial layer may include a metal material.

In an embodiment, the one surface of the substrate may be treated by using plasma or may be coated with a hydrophobic organic material.

In an embodiment, the one surface of the substrate may be a planar surface.

In an embodiment, the substrate transfer unit may include: a plurality of carrier rollers arranged along a transfer direction of the substrate; a driving unit configured to rotate at least one of the carrier rollers; and a belt surrounding the carrier rollers, the belt being rotated by rotational force of the carrier rollers.

In an embodiment, the apparatus may further include a substrate support member disposed to face the pressing unit and configured to support the substrate pressed by the pressing unit.

In an embodiment, the apparatus may further include a cleaning unit configured to clean the support film to which the functional film adheres, the support film being transferred from the pressing unit to the winding unit.

More specific descriptions of other embodiments will be included in a detailed description and figures.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a schematic view of an apparatus for manufacturing a flexible integrated substrate according to an embodiment of the inventive concept;

FIG. 2 is a block diagram illustrating a portion of the apparatus for manufacturing the flexible integrated substrate of FIG. 1;

FIG. 3 is a perspective view of a substrate transferred by a substrate transfer unit of the apparatus for manufacturing the flexible integrated substrate of FIG. 1;

FIG. 4 is a cross-sectional view taken along I-I′ line of FIG. 3;

FIG. 5 is a perspective view illustrating the substrate transfer unit of the apparatus for manufacturing the flexible integrated substrate of FIG. 1;

FIG. 6 is a schematic view illustrating a state in which a pressing unit of the apparatus for manufacturing the flexible integrated substrate of FIG. 1 presses a support film to manufacture the flexible integrated substrate;

FIG. 7 is a cross-sectional view illustrating the state in which the pressing unit of the apparatus for manufacturing the flexible integrated substrate of FIG. 1 presses the support film to manufacture the flexible integrated substrate;

FIG. 8 is a cross-sectional view taken along II-II′ line of FIG. 6;

FIG. 9 is a cross-sectional view taken along line of FIG. 6;

FIG. 10 is a cross-sectional view taken along IV-IV′ line of FIG. 6;

FIG. 11 is a view illustrating a state in which a first mark recognizing unit of FIG. 1 recognizes a first alignment mark;

FIG. 12 is a view illustrating a screen through which the first mark recognizing unit of FIG. 11 recognizes the first alignment mark;

FIG. 13 is a view illustrating a state in which a second mark recognizing unit of FIG. 1 recognizes a second alignment mark;

FIG. 14 is a view illustrating a screen through which the second mark recognizing unit of FIG. 13 recognizes the second alignment mark;

FIG. 15 is a schematic view illustrating an apparatus for manufacturing a flexible integrated substrate according to an embodiment of the inventive concept;

FIG. 16 is a view illustrating a state in which a first mark recognizing unit of FIG. 15 recognizes the first alignment mark;

FIG. 17 is a view illustrating a state in which a second mark recognizing unit of FIG. 15 recognizes the second alignment mark;

FIG. 18 is a schematic view of an apparatus for manufacturing a flexible integrated substrate according to an embodiment of the inventive concept; and

FIG. 19 is an enlarged view of a portion A of FIG. 18.

### DETAILED DESCRIPTION

Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully transfer the scope of the present disclosure to those skilled in the art. Further, the inventive concept is only defined by scopes of claims. Like numbers refer to like elements throughout.

In the following description, the technical terms are used only to explain a specific exemplary embodiment while not limiting the inventive concept. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as generally understood by those skill in the art. Terms as defined in a commonly used dictionary should be construed as having the same meaning as in an associated technical context, and unless defined apparently in the description, the terms are not ideally or excessively construed as having formal meaning.

Hereinafter, embodiments of the inventive concept will be described in detail with reference to the accompanying drawings.

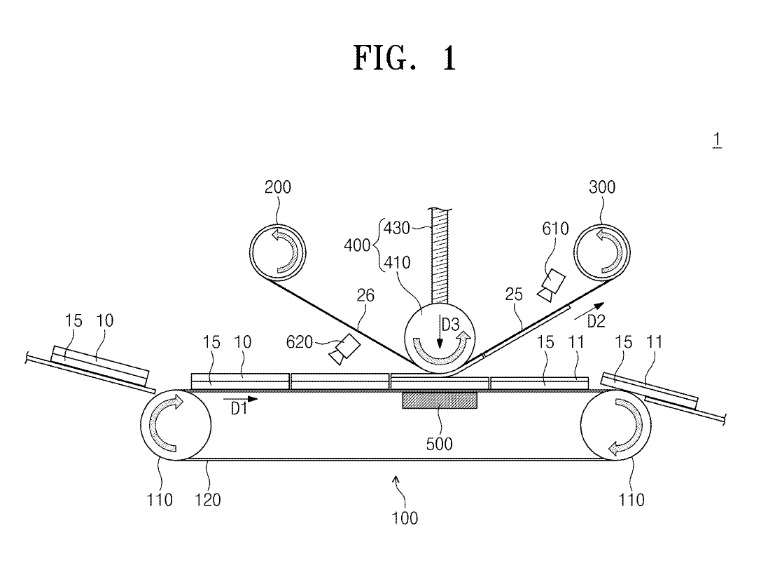

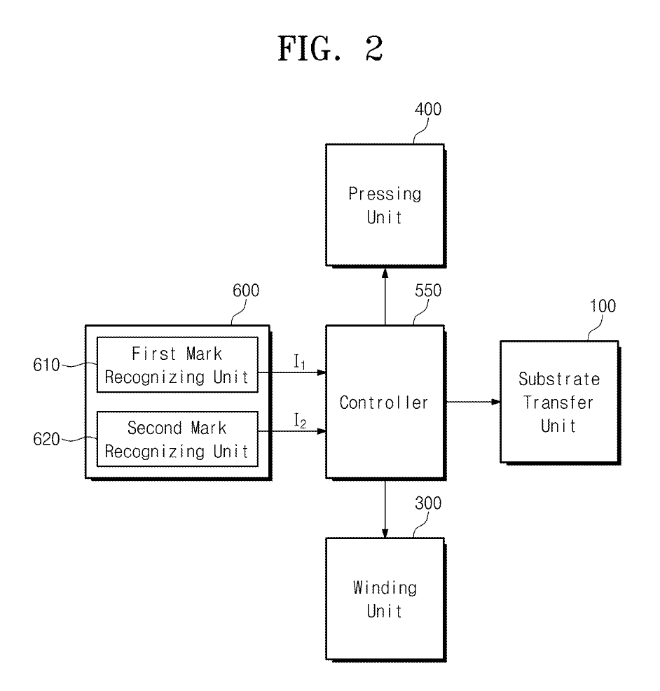

FIG. 1 is a schematic view of an apparatus for manufacturing a flexible integrated substrate according to an embodiment of the inventive concept. FIG. 2 is a block diagram illustrating a portion of the apparatus for manufacturing the flexible integrated substrate of FIG. 1.

Referring to FIG. 1 and FIG. 2, an apparatus 1 for manufacturing a flexible integrated substrate according to an embodiment of the inventive concept may manufacture a flexible integrated substrate 25 by bonding a functional film 12 to a flexible support film 20. The apparatus 1 for manufacturing the flexible integrated substrate may include a substrate transfer unit 100, an unwinding unit 200, a winding unit 300, a pressing unit 400, a substrate support member 500, a mark recognizing unit 600, and a controller 550.

The substrate transfer unit 100 may transfer a substrate 11 on which the functional film 12 is disposed on one surface thereof. Hereinafter, the substrate 11 and the functional film 12 disposed on the one surface of the substrate 11 will be referred to as a substrate part 10. The substrate transfer unit 100 may transfer the substrate part 10 provided from a substrate providing unit (not shown) toward a substrate collecting unit (not shown). The substrate transfer unit 100 may include a belt 120 on which the substrate part 10 is seated, a plurality of carrier rollers 110 disposed in a transfer direction D1 of the substrate 11, and a driving unit 130 rotating at least one of the carrier rollers 110.

A substrate fixing member 15 may be disposed on the belt 120 of the substrate transfer unit 100. The substrate 11 of the substrate part 10 may be inserted into the substrate fixing member 15. As a result, the substrate part 10 may be fixed by the substrate fixing member 15. Since the substrate fixing member 15 fixes the substrate part 10, the substrate part 10 may not move by vibration generated during the transfer process and pressing force of the pressing unit 400. Relevant details will be described later in FIG. 4.

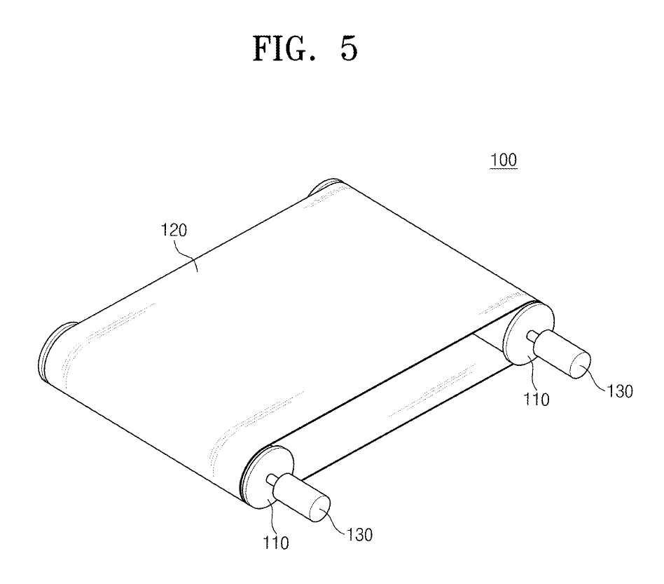

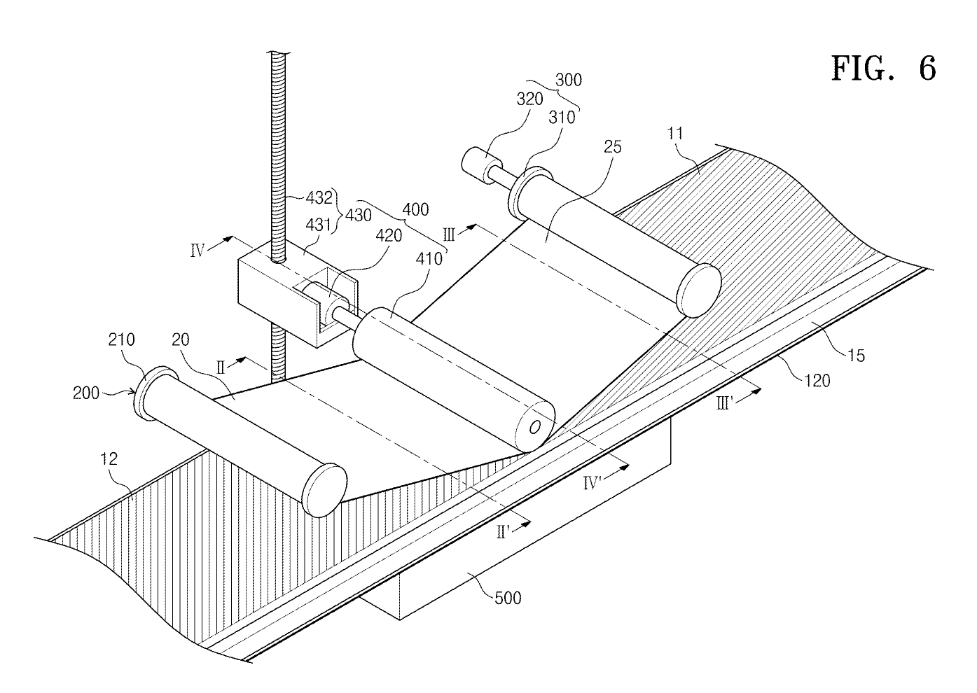

The unwinding unit 200 may unwind the flexible support film 20 wound in a roll shape. In an embodiment of the inventive concept, the unwinding unit 200 may include an unwinding reel 210 around which the support film 20 is wound in a roll shape. The support film 20 wound around the unwinding reel 210 may be unwound to the pressing unit 400 when the support film 20 is wound by the winding unit 300. Alternatively, in another embodiment, the unwinding unit 200 may further include an unwinding driving unit (not shown) rotating the unwinding reel 210 about a virtual rotational axis that passes through a center of the unwinding reel 210. Here, the virtual rotational axis that passes through the center of the unwinding reel 210 may be perpendicular to the transfer direction D1 of the substrate 11. Thus, the unwinding unit 200 may unwind the support film 20 to the pressing unit 400 although the support film is not wound by the winding unit 300. Relevant details will be described later in FIG. 5 and FIG. 6.

The winding unit 300 may be spaced a predetermined distance from the unwinding unit 200. The winding unit 300 may wind the flexible integrated substrate 25, which is provided from the unwinding unit 200, in the roll shape. The support film 20 is continuously unwounded from the unwinding unit 200 and may become the flexible integrated substrate 25 after a process is performed and then be wound around the winding unit 300. Here, the process may include a process of bonding the functional film 12 to the support film 20. Relevant details will be described later in FIG. 5 and FIG. 6.

The pressing unit 400 may press the support film 20 being transferred from the unwinding unit 200 to the winding unit 300 onto the substrate 11 being transferred. Thus, the pressing unit 400 may allow the functional film 12 disposed on one surface of the substrate 11 to adhere to the support film 20. Relevant details will be described later in FIG. 5 and FIG. 6.

The substrate support member 500 may be disposed to face the pressing unit 400. The substrate support member 500 may support the substrate 11 pressed by the pressing unit 400. In an embodiment of the inventive concept, the substrate support member 500 may be disposed on a portion at which the pressing unit 400 presses the substrate 11. Thus, the support film 20, the substrate part 10, the substrate fixing member 15 and the belt 120 may be disposed between the substrate support member 500 and the pressing unit 400. For example, the substrate support member 500 may be disposed below the belt 120 to support the substrate 11 disposed on the belt 120. Thus, the substrate support member 500 prevents the substrate 11 from moving in a pressing direction D3 by the pressing pressure of the pressing unit 400 to allow the functional film 12 to smoothly adhere to the support film 20.

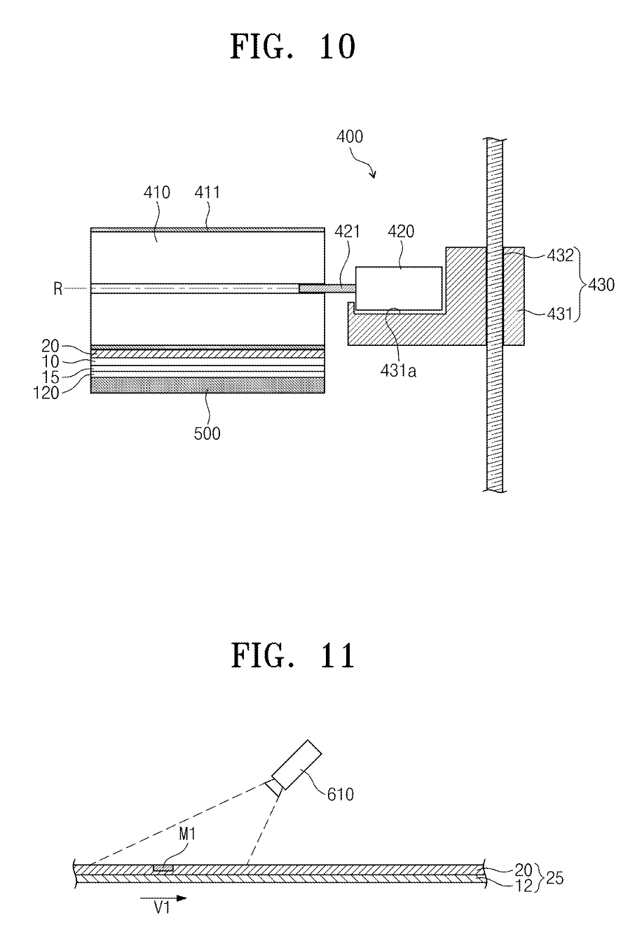

The mark recognizing unit 600 may recognize a first alignment mark M1 of the support film 20 and a second alignment mark M2 of the substrate part 10 to acquire first alignment mark information I1 and second alignment mark information I2. The mark recognizing unit 600 may transmit the first alignment mark information I1 and the second alignment mark information I2 to the controller 550. The mark recognizing unit 600 may include at least one first mark recognizing unit 610 recognizing the first alignment mark M1 and at least one second mark recognizing unit 620 recognizing the second alignment mark M2. In an embodiment of the inventive concept, the first mark recognizing unit 610 may be disposed between the pressing unit 400 and the winding unit 300 to recognize the first alignment mark M1 provided in the support film 20 being transferred from the pressing unit 400 to the winding unit 300. That is, the first mark recognizing unit 610 may be disposed in the transfer direction D2 of the flexible integrated substrate 25. On the other hand, in another embodiment, the first mark recognizing unit 610 may be disposed between the unwinding unit 200 and the pressing unit 400 to recognize the first alignment mark M1 of the support film 20 being transferred from the unwinding unit 200 to the winding unit 300. The second mark recognizing unit 620 may recognize the second alignment mark M2 of the substrate part 10 being transferred to the pressing unit 400. Relevant details will be described later in FIG. 10 to FIG. 13.

The controller 550 may control the substrate transfer unit 100, the winding unit 300 and the pressing unit 400. Also, the controller 550 may control the substrate providing unit (not shown) and the substrate collecting unit (not shown). Relevant details will be described later in FIG. 11 to FIG. 14.

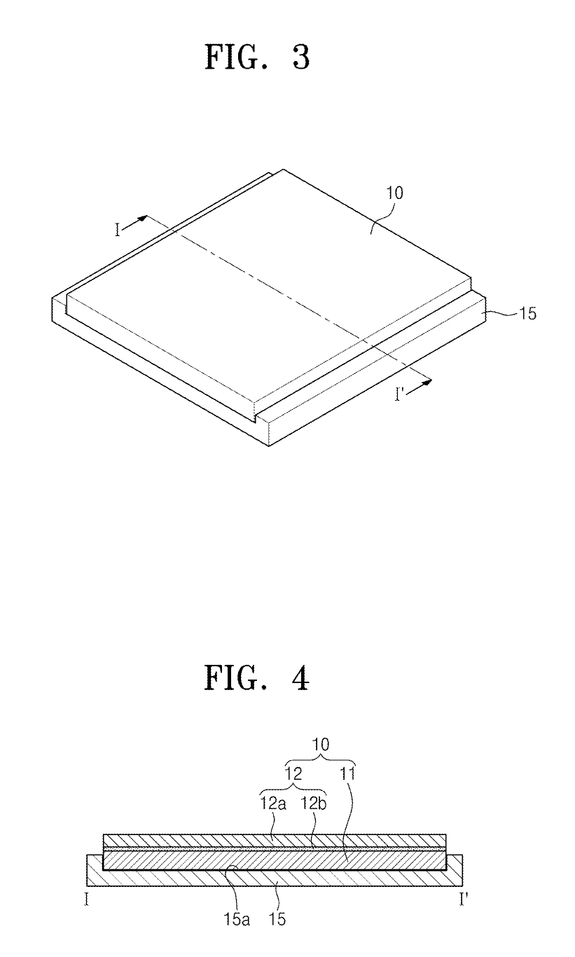

FIG. 3 is a perspective view of a substrate being transferred by the substrate transfer unit of the apparatus for manufacturing the flexible integrated substrate of FIG. 1. FIG. 4 is a cross-sectional view cut along I-I′ line of FIG. 3.

Referring to FIG. 3 and FIG. 4, the substrate fixing member 15 may fix the substrate part 10. The substrate fixing member 15 may include a fixing groove 15a into which at least a portion of the substrate 11 is inserted. The apparatus (see reference numeral 1 of FIG. 1) for manufacturing the flexible integrated substrate in an embodiment of the inventive concept may include a separate substrate fixing member 15 fixing the substrate 11. In another embodiment, the substrate 11 may be inserted into a fixing groove (now shown) defined in the belt 120 of the substrate transfer unit 100 and then fixed to the fixing groove (not shown).

The functional film 12 may be disposed on the one surface of the substrate 11. For example, the functional film 12 may be disposed on a top surface of the substrate 11. Thus, the substrate 11 may support the functional film 12. The substrate 11 may include a ceramic material. That is, the substrate 11 may be a ceramic substrate. However, the embodiment of the inventive concept is not limited thereto. For example, the substrate 11 may be one of a silicone substrate, a glass substrate, an insulating substrate, and a polymer substrate. The substrate 11 may include a material having superior rigidity to endure the pressing power of the pressing unit (see reference numeral 400 of FIG. 1). That is, the substrate 11 may be hard. The top surface of the substrate 11 may be a planar surface. The top surface of the substrate 11 may be a smooth surface. Accordingly, a bottom surface of the functional film 12 contacting the top surface of the substrate 11 may be a planar surface. a bottom surface of the functional film 12 may be a smooth surface.

The functional film 12 may include a functional layer 12a and a sacrificial layer 12b. The functional layer 12a may have a thickness of a nano-scale. An electrode pattern and the like may be disposed on the functional layer 12a.

The sacrificial layer 12b may include a material having weak adhesion with respect to the substrate 11. In an embodiment of the inventive concept, the sacrificial layer 12b may include a metallic material. The sacrificial layer 12b may be formed by depositing the metallic material on the top surface of the substrate 11. The metallic material and the ceramic material may weakly adhere to each other due to their characteristics different from each other. Thus, the sacrificial layer 12b may be easily delaminated from the top surface of the ceramic substrate 11. On the other hand, in another embodiment, the sacrificial layer 12b may include one having weak adhesion of amorphous silicon, a polymer material, and an oxide film.

The functional film 12 may further include a polymer layer (not shown) disposed on the functional layer 12a. The polymer layer may be formed by applying a liquid polymer onto the functional layer 12a and then hardening the liquid polymer. As the liquid polymer is hardened, the sacrificial layer, the functional layer, and the polymer layer may be firmly coupled to each other. Thus, the one support film may be formed.

In an embodiment of the inventive concept, the top surface of the substrate 11 may be treated by using plasma. As the top surface of the substrate 11 is treated by using the plasma, the top surface of the substrate 11 may be smoothly etched so that the sacrificial layer 12b of the functional film 12, which will be described later, may be easily delaminated from the ceramic substrate 11. On the other hand, in another embodiment, an organic material layer (not shown) may be disposed between the substrate 11 and the functional film 12. The organic material layer (not shown) may be formed by applying a hydrophobic organic material onto the top surface of the substrate 11. Adhesion between the hydrophobic organic material and the metallic material may be less than that between the metallic material and the ceramic material. Thus, the sacrificial layer 12b may be easily delaminated from the top surface of the ceramic substrate 11.

FIG. 5 is a perspective view illustrating the substrate transfer unit of the apparatus for manufacturing the flexible integrated substrate.

Referring to FIG. 5, the substrate transfer unit 100 may include the belt 120, the plurality of the carrier rollers 110 and the driving unit 130.

The plurality of the carrier rollers 110 may be disposed along the transfer direction D1 of the substrate 11. In an embodiment of the inventive concept, the substrate transfer unit 100 may include two carrier rollers 110. The two carrier rollers 110 may be spaced apart from each other. Each of the carrier rollers 110 may be a cylindrical shape. Each of the carrier rollers 110 may have a curved outer circumferential surface facing a bottom surface of the substrate 11. The carrier rollers 110 may substantially endure weight of the substrate 11 although the circumferential surface of each of the carrier rollers 110 does not contact the substrate 11.

Each of the carrier rollers 110 may rotate about a virtual rotational axis (not shown) that passes through a center of each carrier roller 110. The rotational axes of the carrier rollers 110 may be disposed perpendicular to the transfer direction D1 of the substrate 11.

The belt 120 may surround the plurality of the carrier rollers 110 and rotate by rotational force of the carrier rollers 110. In an embodiment of the inventive concept, the belt 120 may having an outer surface contacting a bottom surface of the substrate fixing member 15. Thus, the belt 120 may rotate by the rotational force of the carrier rollers 110 and transfer the substrate fixing member 15 seated on the outer surface of the belt 120. As the substrate fixing member 15 is transferred by the belt 12, the substrate part 10 fixed by the substrate fixing member 15 may be transferred.

The driving unit 130 may rotate at least one of the plurality of the carrier rollers 110. In an embodiment of the inventive concept, the driving unit 130 may be provided in plurality. Thus, each of the driving units 130 may rotate each of the carrier rollers 110. The driving unit 130 may be a motor. However, the embodiment of the inventive concept is not limited thereto.

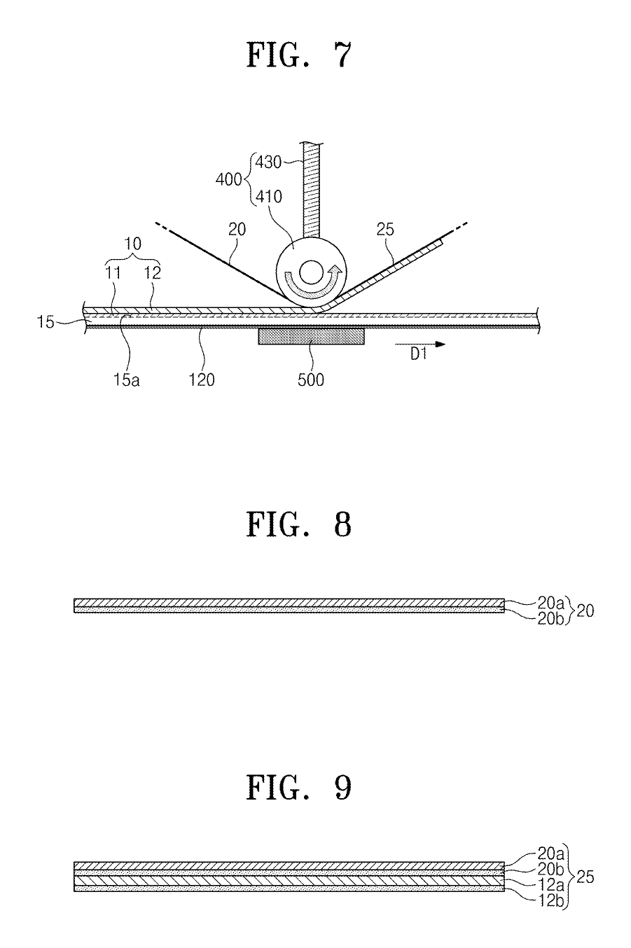

FIG. 6 is a schematic view illustrating a state in which the pressing unit of the apparatus for manufacturing the flexible integrated substrate of FIG. 1 presses the support film to manufacture the flexible integrated substrate. FIG. 7 is a cross-sectional view illustrating the state in which the pressing unit of the apparatus for manufacturing the flexible integrated substrate of FIG. 1 presses the support film to manufacture the flexible integrated substrate. FIG. 8 is a cross-sectional view taken along II-II′ line of FIG. 6. FIG. 9 is a cross-sectional view taken along line of FIG. 6. FIG. 10 is a cross-sectional view taken along IV-IV′ line of FIG. 6.

Referring to FIGS. 6 to 10, the pressing unit 400 according to an embodiment of the inventive concept may be disposed between the unwinding unit 200 and the winding unit 300 to press the support film 20 toward the substrate 11. The pressing unit 400 may include a pressing roller 410, a roller driving unit 420, a roller elevating unit 430, and an elastic member 411.

The pressing roller 410 may be a cylindrical shape. The pressing roller 410 may have a curved outer circumferential surface. The outer circumferential surface of the pressing roller 410 is disposed to face the top surface of the substrate 11. At least a portion of the outer circumferential surface of the pressing roller 410 may contact the support film 20 provided from the unwinding unit 200. That is, the outer circumferential surface of the pressing roller 410 may contact a top surface of the support film 20. Thus, the support film 20 may be disposed between the pressing roller 410 and the substrate part 10. The pressing roller 410 may be disposed at a height lower than that of each of the unwinding unit 200 and the winding unit 300 when pressing the support film 20 toward the substrate 11.

The elastic member 411 may be disposed on at least a portion of the outer circumferential surface of the pressing roller 410. In an embodiment of the inventive concept, the elastic member 411 may be disposed on an entire outer circumferential surface. The elastic member 411 may prevent the substrate 11 from being damaged by the pressing force of the pressing roller 410 when the support film 20 is closely attached to the functional film 12 by the pressing force of the pressing roller 410. The elastic member 411 may include poly-dimethyllesiloxane (PMDS) or polyurethane. However, the embodiment of the inventive concept is not limited thereto.

The roller driving unit 420 may rotate the pressing roller 410 about a virtual rotational axis R that passes through a center of the pressing roller 410. A rotation shaft 421 of the roller driving unit 420 may be connected to the virtual rotational axis R. The roller driving unit 420 may be a motor. However, the embodiment of the inventive concept is not limited thereto.

The roller elevating unit 430 may vertically elevate the pressing roller 410. The roller elevating unit 430 may vertically elevate the roller driving unit 420 to vertically elevate the pressing roller 410. In an embodiment of the inventive concept, the roller elevating unit 430 may include a support part 431 supporting the roller driving unit 420 and an elevating part 432 vertically elevating the support part 431. The support part 431 may include a seat groove (non-designation) in which the roller driving unit 420 may be seated. The support part 431 may include a through hole (non-designation) in a portion except for the seat groove. A screw thread may be provided on an inner circumferential surface of the trough hole (non-designation).

The elevating part 432 may include a driving shaft (non-designation) having an outer circumferential surface on a screw thread is provided and a driving motor (not shown) rotating the driving shaft. The driving shaft (non-designation) may be inserted into the through hole (non-designation). Thus, the screw thread provided on the outer circumferential surface of the driving shaft (non-designation) may be engaged with the screw thread provided on the inner circumferential surface of the through hole (non-designation). The support part 431 may descend when the driving shaft (non-designation) rotates forward by the driving motor (not shown). Thus, the pressing roller 410 may descend to provide the pressing force to the substrate part 10. The support part 431 may ascend when the driving shaft (non-designation) rotates backward by the driving motor (not shown). Thus, the pressing roller 410 ascends to release the pressing force applied to the substrate part 10.

Referring to FIG. 8 and FIG. 9, the support film 20 unwound by the unwinding unit 200 may include a flexible integrated substrate layer 20a and an adhesion layer 20b. The flexible integrated substrate layer 20a may include a flexible material. The adhesion layer 20b may be disposed on a bottom surface the flexible integrated substrate layer 20a. The adhesion layer 20b may adhere to a top surface of the functional film 12 disposed on the substrate 11. The functional film 12 adhering to the support film 20 may be delaminated from the substrate 11 when the support film 20 is transferred from the pressing unit 400 to the winding unit 300. Thus, the flexible integrated substrate 25 including the support film 20 and the functional film 12 may be manufactured. The flexible integrated substrate 25 may be wound in the roll shape by the winding unit 300.

The winding unit 300 may include a first winding reel 310 winding the flexible integrated substrate 25 in the roll shape and a first winding driving unit 320 rotating the first winding reel 310. The first winding driving unit 320 may rotate the first winding reel 310 about a virtual rotational axis (not shown) that passes through a center of the first winding reel 310. The virtual rotational axis of the first winding reel 310 may be perpendicular to the transfer direction D2 of the flexible integrated substrate 25.

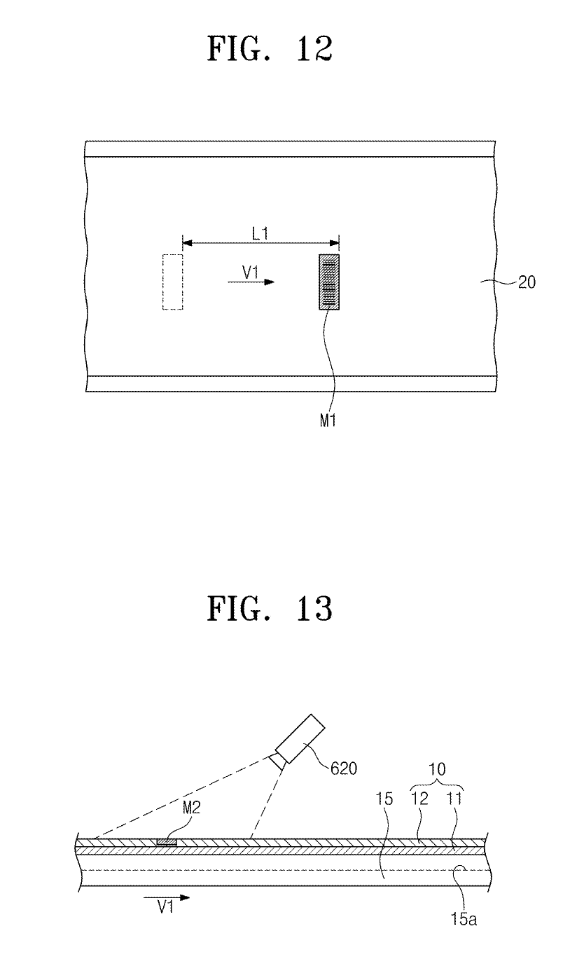

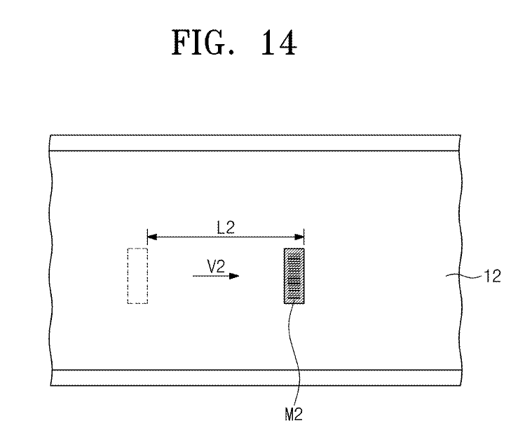

FIG. 11 is a view illustrating a state in which the first mark recognizing unit of FIG. 1 recognizes a first alignment mark. FIG. 12 illustrates a screen through which the first mark recognizing unit of FIG. 11 recognizes the first alignment mark. FIG. 13 is a view illustrating a state in which the second mark recognizing unit of FIG. 1 recognizes a second alignment mark in a functional film. FIG. 14 is a view illustrating a screen through which the second mark recognizing unit of FIG. 13 recognizes the second alignment mark.

Referring to FIGS. 2 and 11 to 14, the controller 550 may receive first alignment mark information I1 and second alignment mark information I2 from the above-described mark recognizing unit. As described above, the mark recognizing unit 600 may include the first mark recognizing unit 610 and the second mark recognizing unit 620. In an embodiment of the inventive concept, the first mark recognizing unit 610 may be an image capturing unit photographing the support film 20 being transferred. The first mark recognizing unit 610 may photograph the first alignment mark M1 disposed on the support film 20. The second mark recognizing unit 620 may be an image capturing unit photographing the substrate 11 being transferred. The second mark recognizing unit 620 may photograph the second alignment mark of the functional film 12 disposed on the substrate 11. In an embodiment of the inventive concept, the second alignment mark M2 may be disposed on the functional film 12. However, the embodiment of the inventive concept is not limited thereto. For example, the second alignment mark M2 may be disposed on the substrate 11 and/or the substrate fixing member 15. The first mark recognizing unit 610 and the second mark recognizing unit 620 may acquire an image by photographing a predetermined area. Accordingly, the first alignment mark information I1 and the second alignment mark information I2 may be image information.

The controller 550 may calculate a transfer speed V2 of the substrate 11 and a transfer speed V1 of the support film 20 on the basis of the first alignment mark information I1 and the second alignment mark information I2. For example, the controller 550 may extract a moving distance L1 of the first alignment mark M1 from the first alignment mark information I1 for a preset first time Δt1. The controller 550 may calculate the transfer speed V1 (V1=L1/Δt1) of the support film 20 from the moving distance L1 of the first alignment mark M1 for a preset first time Δt1. The controller 550 may extract a moving distance L2 of the second alignment mark M2 from the second alignment mark information I2 for a preset second time Δt2. The controller 550 may calculate the transfer speed V2 (V2=L2/Δt2) of the substrate 11 from the moving distance L2 of the second alignment mark M2 for a preset second time Δt2. Here, the first time and the second time may be the same. However, the embodiment of the inventive concept is not limited thereto.

The first alignment mark M1 may include information with respect to the support film 20 being transferred. For example, the first alignment mark M1 may be a bar code including various types of information. Thus, the first alignment mark information I1 transmitted to the controller 550 may include information with respect to the support film 20. The information with respect to the support film 20 may include information with respect to a production time of the support film 20, a material of the support film 20, a size of the support film 20, and the like.

The second alignment mark M2 may include information with respect to the substrate 11 and/or the functional film 12. For example, the second alignment mark M2 may be a bar code including various types of information. Thus, the second alignment mark information I2 transmitted to the controller 550 may include the information with respect to the substrate 11 and/or the functional film 12. The information with respect to the substrate 11 and/or the functional film 12 may include information with respect to a production time, a material, and the like of the substrate and/or the functional film 12.

The controller 550 may control the substrate transfer unit 100 and the winding unit 300 so that the transfer speed V2 of the substrate 11 and the transfer speed V1 of the support film 20 are synchronized with each other. For example, the controller 550 may control the driving unit 130 of the substrate transfer unit 100 and the first winding driving unit 320 of the winding unit 300 so that the transfer speed V2 of the substrate 11 and the transfer speed V1 of the support film 20 are the same.

The controller 550 may control the substrate transfer unit 100 and the roller driving unit 420 so that the calculated transfer speed V1 of the support film 20 and a rotation speed of the pressing roller 410 are synchronized with each other. For example, the controller 550 may control the driving unit 130 of the substrate transfer unit 100 and the roller driving unit 420 so that the calculated transfer speed V1 of the support film 20 and a rotation linear velocity are the same. Here, the rotation linear velocity V may satisfy the following Equation:

Equation: V=2πr/T

(where r is a radius of the pressing roller 410, and T is time taken to make one revolution of the pressing roller 410)

As the controller 550 synchronizes the transfer speed V1 of the support film 20, the transfer speed V2 of the substrate 11 and the rotation linear velocity of the pressing roller 410, the functional film 12 may smoothly adhere to the support film 20. Thus, the flexible integrated substrate 25 may be improved in yield.

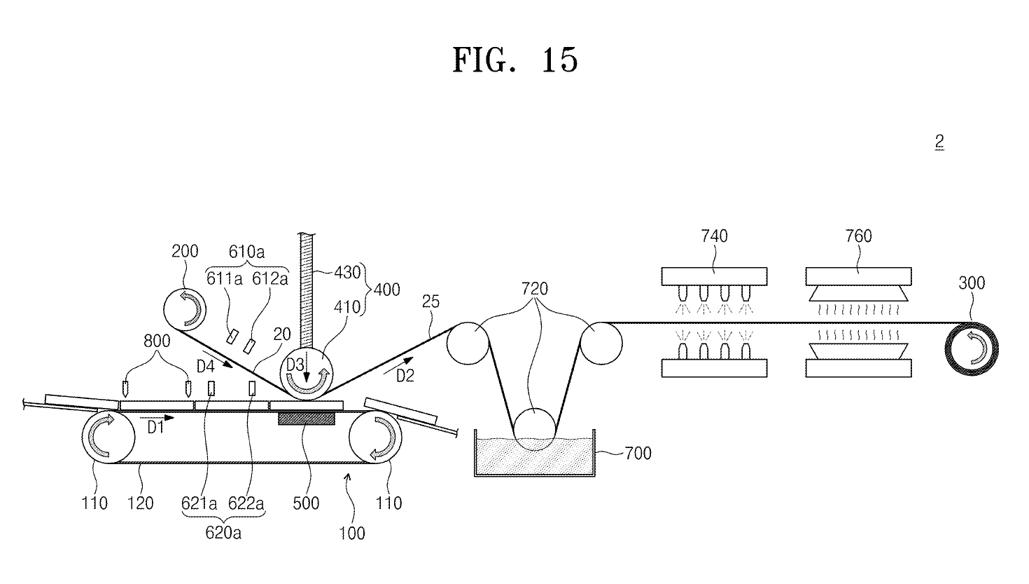

FIG. 15 is a schematic view of an apparatus for manufacturing a flexible integrated substrate according to an embodiment of the inventive concept.

Referring to FIG. 15, an apparatus 2 for manufacturing a flexible integrated substrate according to an embodiment of the inventive concept may include a substrate transfer unit 100, an unwinding unit 200, a winding unit 300, a pressing unit 400, guide rollers 720, a mark recognizing unit 600, a sacrificial layer removing unit 700, a cutting unit 800, a cleaning unit 740, and a drying unit 760. For convenience of description, descriptions with respect to constituents that are substantially the same as those explained with reference to FIGS. 1 to 14 will be omitted.

The cutting unit 800 may be disposed on a transfer path of a substrate 11. The cutting unit 800 may cut a portion of a functional film 12 being transferred toward the pressing unit 400 by the substrate transfer unit 100. For example, when the functional film 12 has a width greater than that of a support film 20, the cutting unit 800 may cut the functional film 12 so that the width of the functional film 12 and the width of the support film 20 correspond to each other. The cutting unit 800 may have a structure in which a sharp blade moves toward the functional film 12 to cut the functional film 12 or a structure in which a laser beam is radiated toward the functional film 12 to cut the functional film 12. However, the embodiment of the inventive concept is not limited thereto. For example, the cutting unit 800 may have various structures capable of cutting the functional film 12.

The guide rollers 720 may be spaced apart from each other between the pressing unit 400 and the winding unit 300. The guide rollers 720 may guide the transfer of the flexible integrated substrate 25 being transferred from the pressing unit 400 to the winding unit 300. Thus, the guide rollers 720 may support the flexible integrated substrate 25 being transferred to the winding unit 300. Each of the guide rollers 720 may be a cylindrical shape. However, the embodiment of the inventive concept is not limited thereto. In another embodiment of the inventive concept, the guide rollers 720 may be spaced apart from each other between the unwinding unit 200 and the pressing unit 400. Thus, the guide rollers 720 may guide the transfer of the support film 20 being transferred from the unwinding unit 200 to the pressing unit 400.

As described above, the functional film 12 may include a sacrificial layer 12b contacting the substrate 11 and a functional layer 12a disposed on the sacrificial layer 12b. Thus, the flexible integrated substrate 25 formed through adhesion of the functional film 12 and the support film 20 may include the sacrificial layer 12b. Since the sacrificial layer 12b is an unnecessary portion in the following processes, the sacrificial layer 12b may be removed.

The sacrificial layer removing unit 700 may remove the sacrificial layer 12b of the functional film 12, which adheres to the support film 12. That is, the sacrificial layer removing unit 700 may remove the sacrificial layer 12b from the flexible integrated substrate 25. The sacrificial layer removing unit 700 may be disposed between the pressing unit 400 and the winding unit 300. The sacrificial layer removing unit 700 may remove the sacrificial layer 12b through wet etching for removing the sacrificial layer 12b by using an etching solution or an organic solution and dry etching for removing the sacrificial layer 12b by using plasma and the like. In an embodiment of the inventive concept, the sacrificial layer removing unit 700 may remove the sacrificial layer 12b by using the wet etching. For example, the sacrificial layer removing unit 700 may include an accommodating part (non-designation) storing the etching solution or the organic solution for removing the sacrificial layer 12b. The sacrificial layer 12b provided in the flexible integrated substrate 25 may be removed by the etching solution or the organic solution stored in the accommodating unit when the flexible integrated substrate 25 is immersed in the etching solution stored in the accommodating unit.

The cleaning unit 740 may be disposed between the pressing unit 400 and the winding unit 300. Thus, the cleaning unit 740 may clean the support film 20 to which the functional film 12 being transferred from the pressing unit 400 to the winding unit 300 adheres. In an embodiment of the inventive concept, the cleaning unit 740 may be disposed between the sacrificial layer removing unit 700 and the winding unit 300. However, the embodiment of the inventive concept is not limited thereto. For example, the cleaning unit 740 may be disposed above and below the flexible integrated substrate 25 being transferred. The cleaning unit 740 may include spray nozzles (non-designation) spraying a cleaning solution onto top and bottom surfaces of the flexible integrated substrate 25.

The drying unit 760 may be disposed between the cleaning unit 740 and the winding unit 300. The drying unit 760 may dry the flexible integrated substrate 25 being transferred from the cleaning unit 740. Thus, the flexible integrated substrate 25 may be wound in the roll shape by the winding unit 300 in a dried state. The cleaning unit 760 may be disposed above and below the flexible integrated substrate 25 being transferred. The drying unit 760 may provide dry air to the top and bottom surfaces of the flexible integrated substrate 25.

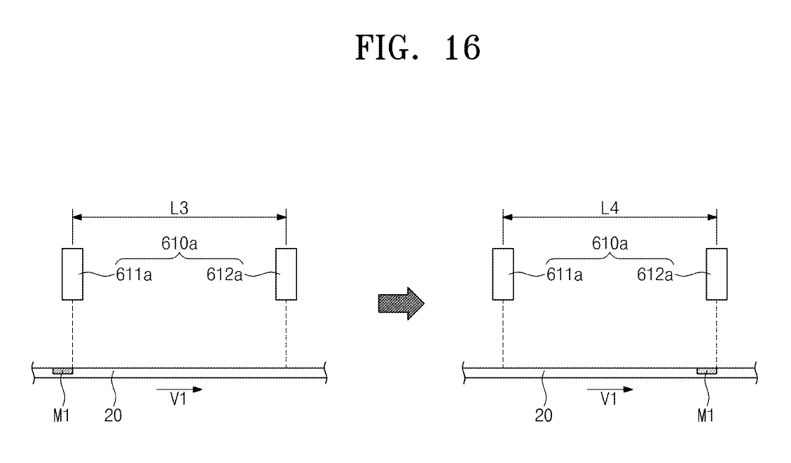

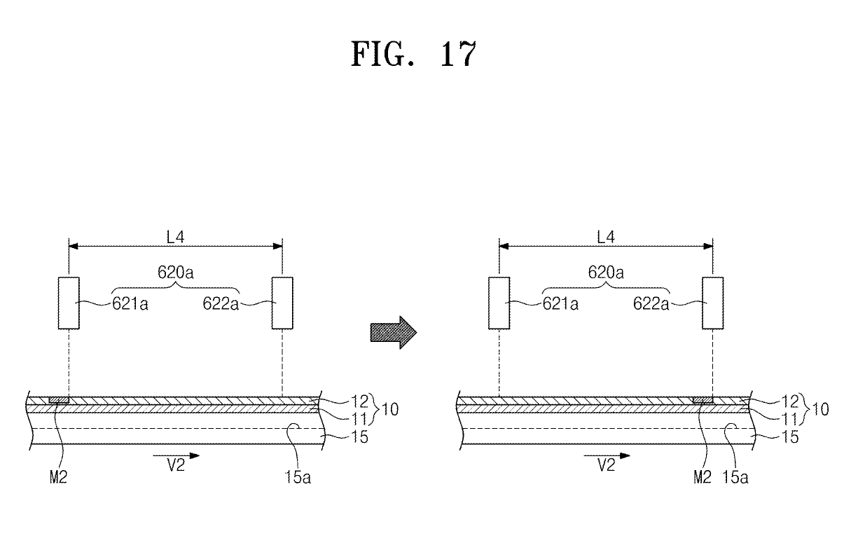

FIG. 16 is a view illustrating a state in which the first mark recognizing unit of FIG. 15 recognizes a first alignment mark. FIG. 17 is a view illustrating an image in which the second mark recognizing unit of FIG. 15 recognizes a second alignment mark.

Referring to FIG. 16 and FIG. 17, the mark recognizing unit 600 according to an embodiment of the inventive concept may be a light sensor. In an embodiment of the inventive concept, the mark recognizing unit may be a laser sensor. However, the embodiment of the inventive concept is not limited thereto. The mark recognizing unit 600 may include a first mark recognizing unit 610a disposed between the pressing unit 400 and the unwinding unit 200 and a second mark recognizing unit 620a disposed on the transfer path of the substrate 11. The first mark recognizing unit 610a may include first and second light sensors 611a and 612a. The second mark recognizing unit 620a may include third and fourth light sensors 621a and 622a.

In an embodiment of the inventive concept, the first and second light sensors 611a and 612a may be spaced a predetermined distance L3 from each other. The first and second light sensors 611a and 612a may be disposed along a transfer path of the support film. That is, the first and second light sensors 611a and 612a may be disposed between the pressing unit 400 and the winding unit 300. The second light sensor 612a may be disposed closer to the winding unit 300 than the first light sensor 611a. Thus, the first light sensor 611a may radiate light in a direction perpendicular to a transfer direction D4 of the support film 20 to recognize the first alignment mark M1 of the support film 20. After the first light sensor 611a recognizes the first alignment mark M1 of the support film 20, the second light sensor 612a may radiate light in the direction perpendicular to the transfer direction D4 of the support film 20 to recognize the first alignment mark M1 of the support film 20. The first alignment mark information I1 recognized by the first and second light sensors 611a and 612a may be transmitted to the controller 550.

The controller 550 may extract a time at which the first light sensor 611a recognizes the first alignment mark M1 and a time at which the second light sensor 612a recognizes the first alignment mark M1 from the alignment mark information I1. The controller 550 may calculate a difference in extracted recognition time of the first light sensor 611a and the second light sensor 612a. The controller 550 may calculate the transfer speed V1 of the support film 20 on the basis of the difference in calculated recognition time and the spaced distance L3 between the first and second light sensors 611a and 612a.

In an embodiment of the inventive concept, the third and fourth light sensors 621a and 622a may be spaced a predetermined distance L4 from each other. The third and fourth light sensors 621a and 622a may be disposed along the transfer path of the substrate 11. The fourth light sensor 622a may be disposed closer to the pressing unit 400 than the third light sensor 621a. Thus, the third light sensor 621a may radiate light in the direction perpendicular to the transfer direction D1 of the substrate 11 to recognize the second alignment mark M2 of the substrate 11 and/or the functional film 12. After the third light sensor 621a recognizes the second alignment mark M2, the fourth light sensor 622a may radiate light in the direction perpendicular to the transfer direction D1 of the substrate 11 to recognize the second alignment mark M2 of the substrate 11 and/or the functional film 12. The second alignment mark information I2 recognized by the third and fourth light sensors 621a and 622a may be transmitted to the controller 550.

The controller 550 may extract a time at which the third light sensor 621a recognizes the second alignment mark M2 and a time at which the fourth light sensor 622a recognizes the second alignment mark M2 from the second alignment mark information I2. The controller 550 may calculate a difference in extracted recognition time of the third light sensor 621a and the fourth light sensor 622a. The controller 550 may calculate the transfer speed V2 of the substrate 11 on the basis of the difference in calculated recognition time and the spaced distance L4 between the third and fourth light sensors 621a and 622a.

The controller 550 may control the substrate transfer unit 100 and the winding unit 300 so that the transfer speed V2 of the substrate 11 and the transfer speed V1 of the support film 20 are synchronized with each other. For example, the controller 550 may control the driving unit 130 of the substrate transfer unit 100 and the first winding driving unit 320 of the winding unit 300 so that the transfer speed V2 of the substrate 11 and the transfer speed V2 of the support film 20 are the same.

The controller 550 may control the substrate transfer unit 100 and the roller driving unit 420 so that the calculated transfer speed V1 of the support film 20 and the rotation speed of the pressing roller 410 are synchronized with each other. For example, the controller 550 may control the driving unit 130 of the substrate transfer unit 100 and the roller driving unit 420 so that the calculated transfer speed V1 of the support film 20 and the rotation linear velocity V of the pressing roller 410 are the same.

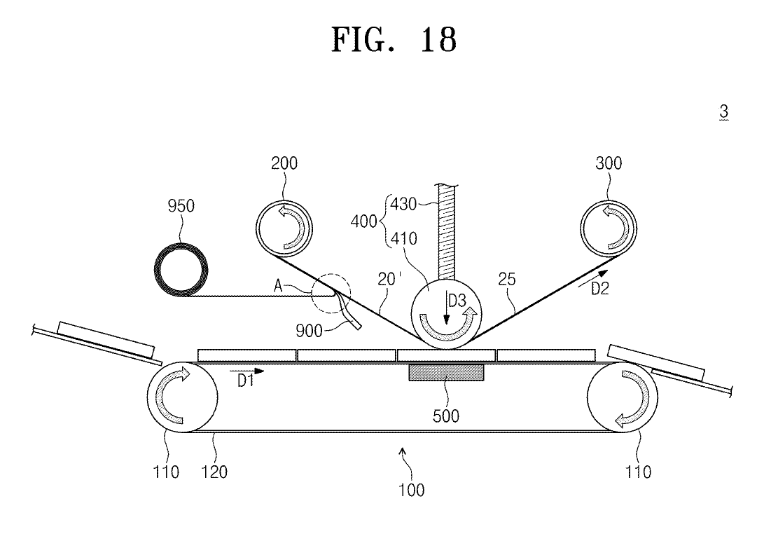

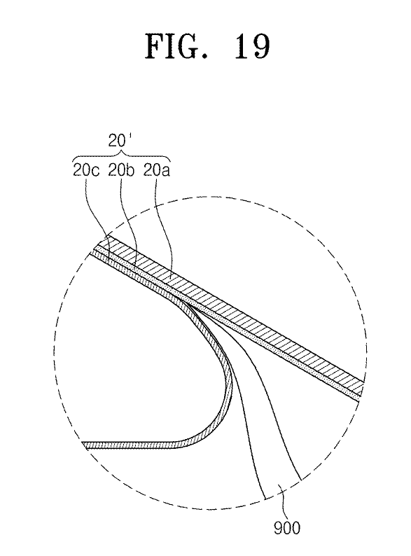

FIG. 18 is a schematic view illustrating the apparatus for manufacturing a flexible integrated substrate according to an embodiment of the inventive concept. FIG. 19 is an enlarged view of a portion A of FIG. 18.

Referring to FIG. 18 and FIG. 19, an apparatus 3 for manufacturing a flexible integrated substrate according to an embodiment of the inventive concept may include a substrate transfer unit 100, an unwinding unit 200, a winding unit 300, a pressing unit 400, a substrate support member 500, a mark recognizing unit 600, a delaminating unit 900, and a protective film winding unit 950. For convenience of description, descriptions with respect to constituents that are substantially the same as those explained with reference to FIGS. 1 to 14 will be omitted.

A support film 20′ may include a flexible integrated substrate layer 20a, an adhesion layer 20b, and a protective film layer 20c. The adhesion layer 20b may be disposed at a bottom surface of the flexible integrated substrate layer 20a. The protective film layer 20c may be disposed on a bottom surface of the adhesion layer 20b. Thus, the adhesion layer 20b may be disposed between the flexible integrated substrate layer 20a and the protective film layer 20c. Thus, the protective film layer 20c protects the adhesion layer 20b of the support film 20′. For example, when the support film 20′ is wound by the unwinding unit 200, the support film 20′ may be in a laminated state. Thus, the adhesion layer 20b of the support film 20′ may adhere to the flexible integrated substrate layer 20a of the adjacent support film 20′. Since the protective film layer 20c is disposed on one surface of the adhesion layer 20b, and the flexible integrated substrate layer 20a is disposed on other surface of the adhesion layer 20b, the support films 20′ and the adhesion layer 20b, which are adjacent to each other, may be prevented from adhere to each other.

The delaminating unit 900 may be disposed between the unwinding unit 200 and the pressing unit 400. The delaminating unit 900 may be disposed on a transfer path of the support film 20′. The delaminating unit 900 may delaminate the protective film layer 20c from the support film 20′ being transferred from the unwinding unit to the pressing unit 400. In an embodiment of the inventive concept, the delaminating unit 900 may have a sharp edge. Thus, the edge of the delaminating unit 900 may be inserted between the adhesion layer 20b and the protective film layer 20c to delaminate the protective film layer 20c from the adhesion layer 20b. On the other hand, in another embodiment, adhesion performance of the adhesion layer 20b may be lost or deteriorated when the adhesion layer 20a is heated at a temperature higher than a predetermined temperature. Thus, the delaminating unit 900 may delaminate the protective film layer 20c from the adhesion layer 20b by applying heat having a predetermined temperature.

The protective film winding unit 950 may wind the protective film layer 20c delaminated from the support film 20′ by the delaminating unit 900 in a roll shape. The protective film winding unit 950 may include a second unwinding reel (non-designation) around which the protective film layer 20c is wound and a second winding driving unit (non-designation) that rotates the second winding reel (non-designation). The second winding reel may rotate about a virtual rotational axis that passes through a center by the second winding driving unit.

The apparatus for manufacturing the flexible integrated substrate of the inventive concept may have the following effects.

The flexible integrated substrate having the planar surface may be continuously manufactured. Thus, the flexible integrated substrate may be improved in productivity.

The technical objective of the present disclosure is not limited to the aforesaid, but other objects not described herein will be clearly understood by those skilled in the art from appended claims.

Although the exemplary embodiments of the inventive concept have been illustrated and described, it is understood that the inventive concept should not be limited to these exemplary embodiments but various changes and modifications can be made by one ordinary skilled in the art within the spirit and scope of the inventive concept as hereinafter claimed and these changes and modifications are not construed independently from the technical spirit and scope of the inventive concept.

What is claimed is:

1. An apparatus for manufacturing a flexible integrated substrate, comprising:
a substrate transfer unit configured to transfer a substrate which a functional film is disposed on one surface thereof;
an unwinding unit configured to unwind a flexible support film wound in a roll shape;
a winding unit configured to wind the support film, which is provided from the unwinding unit, in the roll shape; and
a pressing unit configured to press the support film being transferred from the unwinding unit to the winding unit to the substrate being transferred to allow the functional film to adhere to the support film.

2. The apparatus of claim 1, further comprising a mark recognizing unit configured to recognize at least one first alignment mark provided on the support film being transferred to acquire first alignment mark information and recognize at least one second alignment mark provided on the substrate being transferred to acquire second alignment mark information.

3. The apparatus of claim 2, further comprising a controller configured to control the substrate transfer unit and the winding unit so that a transfer speed of the substrate and a transfer speed of the support film are synchronized with each other on the basis of the first alignment mark information and the second alignment mark information.

4. The apparatus of claim 3, wherein the first alignment mark information comprises moving distance information of the first alignment mark during a preset time, and
the second alignment mark information comprises moving distance information of the second alignment mark during a preset time.

5. The apparatus of claim 2, wherein the mark recognizing unit comprises:
a first mark recognizing unit configured to photograph the support film being transferred; and
a second mark recognizing unit configured to photograph the substrate being transferred.

6. The apparatus of claim 1, wherein the pressing unit comprises:
a pressing roller of which at least a portion of an outer circumferential surface contacts the support film;
a roller driving unit configured to rotate the pressing roller about a virtual rotational axis that passes through a center of the pressing roller; and
a roller elevating unit configured to elevate the pressing roller.

7. The apparatus of claim 6, further comprising:
a mark recognizing unit configured to recognize a first alignment mark provided on the support film being transferred to acquire first alignment mark information; and
a controller configured to calculate a transfer speed of the support film on the basis of the first alignment mark information and control the winding unit and the roller driving unit so that the calculated transfer speed of the support film and a rotating speed of the pressing roller are synchronized with each other.

8. The apparatus of claim 6, wherein the pressing unit further comprises an elastic member surrounding the outer circumferential surface of the pressing roller.

9. The apparatus of claim 1, further comprising a cutting unit configured to cut a portion of the functional film provided on the substrate being transferred toward the pressing unit.

10. The apparatus of claim 1, wherein the support film comprises an adhesion layer configured to bond the functional film to the support film.

11. The apparatus of claim 10, wherein the support film further comprises a protective film layer disposed on one surface of the adhesion layer.

12. The apparatus of claim 11, further comprising a delaminating unit configured to separate the protective film layer from the support film being transferred from the unwinding unit to the pressing unit.

13. The apparatus of claim 12, further comprising a protective film winding unit configured to wind the protective film layer, which is separated from the support film by the delaminating unit, in the roll shape.

14. The apparatus of claim 1, wherein the functional film comprises a sacrificial layer contacting the substrate, and
the apparatus further comprises a sacrificial layer removing unit configured to remove the sacrificial layer of the functional film adhering to the support film.

15. The apparatus of claim 14, wherein the substrate comprises a ceramic material, and
the sacrificial layer comprises a metal material.

16. The apparatus of claim 14, wherein the one surface of the substrate is treated by using plasma or coated with a hydrophobic organic material.

17. The apparatus of claim 1, wherein the one surface of the substrate is a planar surface.

18. The apparatus of claim 1, wherein the substrate transfer unit comprises:
a plurality of carrier rollers arranged along a transfer direction of the substrate;
a driving unit configured to rotate at least one of the carrier rollers; and
a belt configured to surround the carrier rollers, the belt being rotated by rotational force of the carrier rollers.

19. The apparatus of claim 1, further comprising a substrate support member disposed to face the pressing unit and configured to support the substrate pressed by the pressing unit.

20. The apparatus of claim 1, further comprising a cleaning unit configured to clean the support film to which the functional film adheres, the support film being transferred from the pressing unit to the winding unit.
